(19) United States
(12) Patent Application Publication
(10) Pub. No.: US 2014/0283127 A1
(43) Pub. Date: Sep. 18, 2014

(54) Masking sensitive data in HTML while allowing data updates without modifying client and server

(71) Applicant: HCL Technologies Limited, Chennai (IN)

(72) Inventors: Simy Chacko, Hyderabad (IN); Gopi Krishna Durbhaka, Hyderabad (IN)

(73) Assignee: HCL Technologies Limited, Chennai (IN)

(21) Appl. No.: 13/947,059

(22) Filed: Jul. 20, 2013

(30) Foreign Application Priority Data
Mar. 14, 2013 (IN) 1105/CHE/2013

(51) Int. Cl. G06F 21/62

(52) U.S. Cl. CPC G06F 21/62
USPC 726/28; 726/26

(57) ABSTRACT

The principal object of this embodiment is to propose a method and system for masking sensitive data in web applications while allowing data updates without modifying client and server by intercepting the data live at HTTP/HTTPS network layer, improving the data security of data, providing authorized and restricted access for visibility of information to the users.

### PRIORITY DETAILS

The present application is based on, and claims priority from, Indian Application Number 1105/CHE/2013, filed on 14 Mar., 2013, the disclosure of which is hereby incorporated by reference herein.

### TECHNICAL FIELD

This embodiment relates to computer based networks and more particularly to data transfer across computer based networks.

### BACKGROUND

Currently, access to internet has increased and as a result, a user may perform multiple tasks on the internet. While performing the tasks, the user may expose a lot of his important information on the internet. Examples of the information may comprise of email address, credit card information, personal information (name, age, address and so on), financial information, health information and so on.

Data masking is a technique wherein sensitive portions of data are replaced with other data, wherein the other data may be similar to the real data. There are multiple data masking techniques in use today to hide/mask the critical data from the users. But this requires modification to sever and client. Also, the present data masking techniques do not provide the ability to permit data updation.

### OBJECT OF EMBODIMENT

The principal object of this embodiment is to propose a method and system for masking sensitive data in web applications while allowing data updates without modifying client and server by intercepting the data live at HTTP/HTTPS network layer, improving the data security of data, providing authorized and restricted access for visibility of information to the users.

### STATEMENT OF EMBODIMENT

Accordingly the embodiment provides a method for enabling masking of data in a web application, the method comprising of masking sensitive data in traffic related to the web application by an interceptor, on the interceptor detecting sensitive data in the web application, wherein the interceptor intercepts the traffic from a server to a client; sending the traffic by the interceptor to the client; replacing the mask with the sensitive data by the interceptor, on the interceptor intercepting traffic from the client to the server and the interceptor detecting the mask; and sending the traffic by the interceptor to the server.

Also, provided herein is an interceptor for masking of data in a web application, the interceptor configured for masking sensitive data in traffic related to the web application, on the interceptor detecting sensitive data in the web application, wherein the interceptor intercepts the traffic from a server to a client; sending the traffic to the client; replacing the mask with the sensitive data, on the interceptor intercepting traffic from the client to the server and the interceptor detecting the mask; and sending the traffic to the server.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This embodiment is illustrated in the accompanying drawings, through out which like reference letters indicate corresponding parts in the various figures. The embodiments herein will be better understood from the following description with reference to the drawings, in which:

FIG. 1 depicts a client accessing a web application residing on a web server, according to embodiments as disclosed herein;

FIG. 2 depicts an interceptor module, according to embodiments as disclosed herein;

FIG. 3 is a flowchart depicting the process of a server sending data to a client, according to embodiments as disclosed herein; and

FIG. 4 is a flowchart depicting the process of a client sending data to a server, according to embodiments as disclosed herein.

### DETAILED DESCRIPTION OF EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein achieve a method and system for masking sensitive data in web applications while allowing data updates without modifying client and server, improving the data security of data, providing authorized and restricted access for visibility of information to the users. Referring now to the drawings, and more particularly to FIGS. 1 through 4, where similar reference characters denote corresponding features consistently throughout the figures, there are shown preferred embodiments.

FIG. 1 depicts a client accessing a web application residing on a web server, according to embodiments as disclosed herein. The client 102 may be at least one of a computer, a laptop, a portable computing device, a tablet, a mobile phone, a Personal Digital Assistant (PDA), a television, another web server or any other device capable of accessing the web server 103 using an Internet Protocol (IP) based network. The term web application herein may refer to a web page, a user fillable form (such as a login page, a registration page, a questionnaire or any other form with at least one field capable of being filled by the user) and so on. The client 102 may access the web server using an IP based network.

An interceptor module 101 may be present in the communication path between the client 102 and the server 103. The interceptor 101 may be present within the network layer. The interceptor 101 may be present in the server 103, the client 102 or any other module present in the communication path between the client 102 and the server 103 (such as a firewall, proxy server and so on). The interceptor 101 is configured for masking sensitive data in web applications and ensures the sensitive data is visible only to authenticated entities.

The interceptor 101 intercepts the HTTP (Hypertext Transfer Protocol)/HTTPS (Hypertext Transfer Protocol Secure) traffic at the network layer. The interceptor 101 modifies the traffic from the web server 103 to the client 102 by masking sensitive data. The sensitive data may be indicated by a user of the client 102 and may be based on the structure of the web application, of which the interceptor 101 may be aware. The interceptor 101 may mask the sensitive data by replacing the sensitive data in the traffic with an identifier. The identifier may be at least one of a sequence number or a data-hash like MD5. The identifier may contain a pointer to the storage where the interceptor 101 has stored the sensitive data which has been masked. The interceptor 101 may store the replaced data in a suitable location such as an internal memory. If the sensitive data comprises of images or video, the interceptor 101 may distort the image or video, wherein the distortion may be in the form of blurring, watermarking and so on. In another embodiment herein, the identifier may be opaque visual blocks. The interceptor 101 may use a suitable means such as DIV tags to create the opaque visual blocks.

On the client 102 sending traffic to the web server 103, the interceptor 101 checks the traffic for masked data. On detecting masked data, the interceptor 101 replaces the identifier with the original sensitive data. The interceptor 101 may fetch the original sensitive data from the suitable location used for storing the replaced data. The web server 103 may use the pointer present in the identifier to determine the suitable location used for storing the replaced data. The interceptor 101 then sends the traffic to the web server 103, wherein the traffic comprises of at least one field updated by the user and the sensitive data.

In an embodiment herein, the interceptor 101 may disable the clipboard access by modifying the live HTTP traffic, along with the option of viewing the source code. There shall be restricted access to view the source code of certain URLs specified based on the access levels through login credentials.

In an embodiment herein, the interceptor 101 may restrict the caching of application data especially images by modifying HTTP headers and hence the protection of data shall be highly secure. The interceptor 101 may further avoid data getting saved in client machine.

The interceptor 101 may provide a means to define the structure of the web application. The interceptor 101 may provide a means for a user to set policies such as the applications to be masked, the fields to be masked and so on.

The interceptor 101 may provide a means to update structure of a web application, on any changes being made to the web application or desiring to block other data.

In an embodiment herein, the interceptor 101 is configured for identifying any deviation from the structure of a web application as defined by the user. On identifying any deviation, the interceptor 101 may be configured to block the entire application.

When accessing certain specified web applications that hold secure and sensitive data, the interceptor 101 may insert a ‘User acceptance confirmation’ dialog in the live traffic. A user will be able to view the web application only after its acknowledgement.

Though the above embodiments describe the interceptor 101 present in the client 102 and enabling communication between the client 102 and the web server 103, it may be obvious to a person of ordinary skill in the art that the interceptor 101 may be present in any device which communicates using the IP based network such as a web server which communicates with a client, a web server which communicates with another web server and so on.

FIG. 2 depicts an interceptor module, according to embodiments as disclosed herein. The interceptor 101 as depicted comprises of a controller 201, a masking module 202 and an interface 203. The interceptor 101 may further be associated with a database 204. The memory 204 may be a suitable storage location accessible to the interceptor 101. The memory 204 may be located internal to the client 102. The memory 204 may also be located external to the client 102.

The controller 201 intercepts the HTTP (Hypertext Transfer Protocol)/HTTPS (Hypertext Transfer Protocol Secure) traffic at the network layer, via the interface 203. The masking module 202 modifies the traffic from the web server 103 to the client 102 by masking sensitive data, based on the policies as set by the user. The sensitive data may be indicated by a user of the client 102 using the interface 203. The interface 203 further enables the user to enter the structure of the web application. In another embodiment herein, an authorized person at the web server 103 may indicate the sensitive data and the structure of the traffic. The masking module 202 may mask the sensitive data by replacing the sensitive data in the traffic with an identifier. The identifier may be at least one of a sequence number or a data-hash like MD5. The controller 201 stores the sensitive data in the database 204. The controller 201 creates a pointer pointing to the location in the database 204, where the sensitive data is stored. The masking module 202 may insert then insert the pointer in the identifier. If the sensitive data comprises of images or video, the masking module 202 may distort the image or video, wherein the distortion may be in the form of blurring, watermarking and so on. In another embodiment herein, the identifier may be opaque visual blocks. The masking module 202 may use a suitable means such as DIV tags to create the opaque visual blocks.

On the client 102 sending traffic to the web server 103, the controller 201 checks the traffic for masked data. On detecting masked data, the controller 201 replaces the identifier with the original sensitive data. The controller 201 may fetch the original sensitive data from the memory 204. The controller 201 may use the pointer present in the identifier to determine the specific location in the memory 204. The controller 201 then sends the traffic to the web server 103, wherein the traffic comprises of at least one field updated by the user and the sensitive data.

In an embodiment herein, the controller 201 may disable the clipboard access by modifying the live HTTP traffic, along with the option of viewing the source code. There shall be restricted access to view the source code of certain URLs specified based on the access levels through login credentials.

In an embodiment herein, the controller 201 may restrict the caching of application data especially images by modifying HTTP headers and hence the protection of data shall be highly secure. The controller 201 may further avoid data getting saved in client machine.

The interface 203 enables defining the structure of the web application. The interface 203 enables setting up of policies such as the sections to be masked, the fields to be masked and so on.

The interface 203 enables updates to the structure of a web application, on any changes being made to the web application or desiring to block other data.

In an embodiment herein, the controller 201 is configured for identifying any deviation from the structure of a web application as defined by the user. On identifying any deviation, the controller 201 may be configured to block the entire application.

FIG. 3 is a flowchart depicting the process of a server sending data to a client, according to embodiments as disclosed herein. The interceptor 101 intercepts (301) the HTTP (Hypertext Transfer Protocol)/HTTPS (Hypertext Transfer Protocol Secure) traffic at the network layer, wherein the traffic is from the web server 103 to the client 102. The interceptor 101 identifies (302) the sensitive data in the traffic. On identifying the sensitive data, the interceptor 101 takes a copy of the sensitive data (303) and masks (304) the sensitive data. The interceptor 101 may mask the sensitive data by replacing the sensitive data in the traffic with an identifier. In another embodiment herein, the identifier may be opaque visual blocks. The identifier may contain a pointer to the storage where the interceptor 101 has stored the sensitive data which has been masked. On masking the data, the interceptor 101 transmits (303) the traffic to the client 102. The various actions in method 300 may be performed in the order presented, in a different order or simultaneously. Further, in some embodiments, some actions listed in FIG. 3 may be omitted.

FIG. 4 is a flowchart depicting the process of a client sending data to a server, according to embodiments as disclosed herein. The interceptor 101 on intercepting (401) the traffic from the client 102 to the web server 103, checks (402) if any data has been masked by an identifier. On detecting an identifier, the interceptor 101 fetches (403) the sensitive data from the storage, where the interceptor 101 has stored the data. The interceptor 101 may use the pointer present in the identifier to determine the storage. On fetching the sensitive data, the interceptor 101 replaces (404) the mask with the sensitive data and sends (405) the traffic to the web server 103. The various actions in method 400 may be performed in the order presented, in a different order or simultaneously. Further, in some embodiments, some actions listed in FIG. 4 may be omitted.

Embodiments disclosed herein enable role based data masking by detecting user through proxy authentication. Embodiments herein enable a customized policy for a specific web application. Embodiments herein enable end users to submit form data, even though original data is masked. Embodiments herein disclose a useful technique for outsourcing, delegating tasks, providing external access to intranet and so on.

Embodiments herein enable users to mask datasets that are not critical for a third party to complete their task, hereby reducing the probability of information leakage.

Embodiments herein enable implementation of restricted access levels both from application level and at proxy server to prevent visibility of personal information records to all the users updating the datasets either within the organization/enterprises or to the vendors.

Embodiments herein prevent information leakage of management and administration information and also maintain privacy and confidentiality.

The embodiments disclosed herein can be implemented through at least one software program running on at least one hardware device and performing network management functions to control the network elements. The network elements shown in FIGS. 1 and 2 include blocks which can be at least one of a hardware device, or a combination of hardware device and software module.

The embodiment disclosed herein describes a method and system for masking sensitive data in web applications while allowing data updates without modifying client and server, improving the security of data, providing authorized and restricted access for visibility of information to the users. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A method for enabling masking of data in a web application, the method comprising of
masking sensitive data in traffic related to the web application by an interceptor, on the interceptor detecting sensitive data in the web application, wherein the interceptor intercepts the traffic from a server to a client;
sending the traffic by the interceptor to the client;
replacing the mask with the sensitive data by the interceptor, on the interceptor intercepting traffic from the client to the server and the interceptor detecting the mask; and
sending the traffic by the interceptor to the server.

2. The method, as claimed in claim 1, wherein the method further comprises of copying of the sensitive data by the interceptor, before masking the sensitive data.

3. The method, as claimed in claim 1, wherein sensitive data is indicated by at least one of a user; or an authorized person.

4. The method, as claimed in claim 1, wherein the mask comprises of a pointer, wherein the pointer points to a location where the interceptor stores the sensitive data.

5. The method, as claimed in claim 1, wherein the method further comprises of disabling clipboard access to the traffic by the interceptor.

6. The method, as claimed in claim 1, wherein the method further comprises of providing restricted access to source code of the web application by the interceptor.

7. The method, as claimed in claim 1, wherein the method further comprises of preventing saving of the web application in the client by the interceptor.

8. The method, as claimed in claim 1, wherein the method further comprises of blocking the web application by the interceptor, on the interceptor identifying at least one deviation from the structure of the web application.

9. The method, as claimed in claim 1, wherein the method further comprises of inserting by the interceptor a user acceptance confirmation dialog, before sending the traffic to the client.

10. An interceptor for masking of data in a web application, the interceptor configured for
masking sensitive data in traffic related to the web application, on the interceptor detecting sensitive data in the web application, wherein the interceptor intercepts the traffic from a server to a client;
sending the traffic to the client;
replacing the mask with the sensitive data, on the interceptor intercepting traffic from the client to the server and the interceptor detecting the mask; and
sending the traffic to the server.

11. The interceptor, as claimed in claim 10, wherein the interceptor is further configured for copying of the sensitive data, before masking the sensitive data.

12. The interceptor, as claimed in claim 10, wherein the interceptor is further configured for enabling at least one of a user; or an authorized person to indicate the sensitive data.

13. The interceptor, as claimed in claim 10, wherein the interceptor is further configured for inserting a pointer in the mask, wherein the pointer points to a location where the interceptor stores the sensitive data.

14. The interceptor, as claimed in claim 10, wherein the interceptor is further configured for disabling clipboard access to the traffic.

15. The interceptor, as claimed in claim 10, wherein the interceptor is further configured for providing restricted access to source code of the web application.

16. The interceptor, as claimed in claim 10, wherein the interceptor is further configured for preventing saving of the web application in the client.

17. The interceptor, as claimed in claim 10, wherein the interceptor is further configured for blocking the web application, on the interceptor identifying at least one deviation from the structure of the web application.

18. The interceptor, as claimed in claim 10, wherein the interceptor is further configured for inserting a user acceptance confirmation dialog, before sending the traffic to the client.
